(19) United States
(12) Patent Application Publication
(10) Pub. No.: US 2025/0006933 A1
(43) Pub. Date: Jan. 2, 2025

(54) FUNCTIONALIZED SILICON NANOPARTICLES, COMPOSITE MATERIALS INCLUDING THEM, AND PREPARATION AND USES THEREOF

(71) Applicant: Aspen Aerogels, Inc., Northborough, MA (US)

(72) Inventors: Zhifei Li, Marlborough, MA (US); Wei Xie, Everett, MA (US)

(73) Assignee: Aspen Aerogels, Inc., Northborough, MA (US)

(21) Appl. No.: 18/829,875

(22) Filed: Sep. 10, 2024

Related U.S. Application Data
(63) Continuation of application No. PCT/US2023/070420, filed on Jul. 18, 2023.
(60) Provisional application No. 63/390,825, filed on Jul. 20, 2022.

(51) Int. Cl. H01M 4/62; H01M 4/02; H01M 4/134; H01M 4/38

(52) U.S. Cl. CPC H01M 4/62; H01M 4/134; H01M 4/386; H01M 2004/021

(57) ABSTRACT

Provided herein are composite materials for use in electrical energy storage systems (e.g., high-capacity batteries) and methods for preparing the same. The composite materials of the present disclosure include a plurality of covalently functionalized silicon particles and a polymer network. Individual silicon particles within the plurality of silicon particles are dispersed throughout the polymer network. Covalently attached functional groups to a surface of the plurality of the silicon particles enable dispersion of the silicon particles throughout the polymer network.

### CROSS REFERENCES TO RELATED APPLICATIONS

This application is a continuation of International PCT Application No. PCT/US2023/070420, filed Jul. 18, 2023 which claims priority to and the benefit of U.S. Provisional Patent Application No. 63/390,825, filed Jul. 20, 2022, which is herein incorporated by reference in its entirety.

### FIELD OF THE TECHNOLOGY

The present disclosure relates generally to covalently functionalized silicon particles, composite materials containing the covalently functionalized silicon particles and methods for preparing the same. More specifically, it relates to materials and methods for producing composite materials comprising covalently functionalized nanoscale silicon particles for use in an electrical energy storage system such as high-capacity batteries.

### BACKGROUND

High-capacity battery materials e.g., lithium-ion batteries have found wide application in power-driven and energy storage systems. Rechargeable lithium-ion batteries (LIBs) are used in diverse applications ranging from small-sized consumer electronic devices to midsized electric vehicles to the large-scale electricity grid. In their basic form, a LIB cell contains two electrodes at which redox reactions occur during electrochemical cycling, an electrolyte that transports lithium-ions between the electrodes, and a separator that prevents the electrodes from contact with each other while allowing the movement of ions. Commercial LIBs typically contain graphite as the electrochemically active material in the negative electrode (anode).

A major drawback of conventional LIBs is the limited capacity of graphite; in other words, graphite can accommodate only limited amounts of lithium. With the ever-increasing demand for maximizing the energy density of energy storage systems, improving the energy density of Li-ion batteries is crucial to enable mass-market penetration of electric vehicles, grid-scale energy storage, and next-generation consumer electronics. It is known that silicon has a greater affinity for lithium compared to graphite and is capable of storing significantly higher amounts of lithium than graphite, theoretically resulting in ultrahigh theoretical capacity. By comparison, silicon has been shown to have a high theoretical gravimetric capacity, approximately 4200 mAh/g, compared to only 372 mAh/g for graphite. Therefore, silicon (Si) active material has been considered as promising candidate for next-generation anodes in lithium-ion batteries (LIBs).

However, the practical application and the commercialization of silicon-based electrodes has been hindered by suppressed electrochemical properties, which arise from large volume changes and deteriorated electrode architecture during the cycling process. The volume of Si can expand approximately 400% of its original size during lithiation (the insertion of lithium-ions into silicon), then reducing to a varying size during de-lithiation (the extraction of lithium-ions from silicon); graphite, in comparison, displays an ˜10% volume change. The significant volume change poses a real challenge for Si electrodes to retain its morphology over cycling.

With each cycle, the expansion produces stress and strain on the silicon, causing cracks and breakage. The process of the silicon breaking down is known as pulverization. Due to this pulverization, electrical isolation of silicon fragments causes a loss in contact with neighboring fragments. In addition, the space created from the expansion pushes surrounding conducting material away from the active material and also causes a loss of contact, resulting in low electrical conductivity. Without strong electrical contact with the current collector, the silicon fragments are not lithiated or able to contribute to the battery's capacity. This behavior yields low-capacity stability and rapid capacity degradation over a number of cycles. The decrease in capacity during charging and discharging cycles is referred to as fading or continuous capacity decrease and is generally irreversible.

The particle size of the silicon particles can play a role in how quickly the battery performance declines. Without being bound by theory, nanometer-sized silicon particles have better capability in accommodating the volume change of Si due to their larger specific surface area and higher average binding energy per atom at the surface. These materials can thus minimize the stress on them over volume change and avoid cracking or pulverization of their structures and reduce irreversible capacity and enhance cycling stability.

Furthermore, the chemical properties, surface properties and morphology of silicon particles can affect the agglomeration, processing, resistance to stress, and electrochemical properties of the silicon particles.

### SUMMARY

Embodiments disclosed herein address one or more of the problems and deficiencies identified above by providing improved battery components e.g., anode material, improved batteries made therefrom, and methods of making and using the same. However, it is contemplated that the present disclosure may prove useful in addressing other problems and deficiencies in a number of technical areas. Therefore, the claimed subject matter should not necessarily be construed as limited to addressing any of the particular problems or deficiencies discussed herein.

It is an object of the present disclosure to obviate or mitigate at least one disadvantage of previous methods and materials for improving performance of high-capacity batteries, such as, e.g., lithium-ion batteries (e.g., cycling stability, battery lifetime).

In one general aspect, the materials provided in the present disclosure may advantageously prevent or mitigate rapid capacity fading (e.g., within at least 10 cycles) of high-capacity batteries including Si active material.

In one aspect, provided herein is a plurality of covalently functionalized silicon particles. The covalently functionalized silicon particles of the present disclosure may increase silicon mass loading to the high-capacity batteries, relative to the high-capacity batteries having electrodes which do not possess the composite material of the present disclosure e.g., electrodes having non-functionalized silicon particles.

In one aspect, the covalently functionalized silicon particles provided herein may possess improved dispersion properties within a continuous phase, a medium, or a network compared to the non-functionalized silicon particles. Without wishing to be bound by theory, improved dispersion of the covalently functionalized silicon particles may increase Si mass loading to the high-capacity batteries. The improved dispersion of functionalized silicon particles can prevent the agglomeration of silicon particles during the synthesis, and therefore, minimize the fusing of silicon particles during the pyrolysis process. This leads to better dispersion of silicon particles in a matrix e.g., a polymer network which reduces the anisotropic volume expansion during lithiation and improves the electric connection between the silicon particles and the matrix. Improved dispersion of the covalently functionalized silicon particles may reduce the stress exerted on a matrix in which the functionalized silicon particles are dispersed compared to the stress exerted by non-functionalized silicon particles during charging and discharging processes.

The composite materials of the present technology can improve the performance of lithium-ion batteries, relative to lithium-ion batteries having electrodes which do not possess the composite material of the present disclosure.

In one aspect provided herein is a composite material comprising: a plurality of silicon particles, wherein a surface of the plurality of the silicon particles includes covalently attached functional groups selected from —OH, —COOH, —C—O—C—, —NH₂, —NHR, or combinations thereof; and a polymer network, e.g., a porous polymer network, wherein individual silicon particles within the plurality of silicon particles are dispersed throughout the polymer network.

In some embodiments, the surface of the individual silicon particles within the plurality of silicon particles includes silane groups. In some embodiments, said covalently attached functional groups are formed from molecules selected from 3-aminopropyltriethoxysilane (APTES), 3-aminopropyltrimethoxysilane (APTMS), N-(2-aminoethyl)-3-aminopropyltriethoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof.

In some embodiments, the polymer network is a sol-gel solution. In some instances, the sol-gel solution comprises an aerogel precursor, a xerogel precursor, an ambigel precursor, an aerogel-xerogel hybrid material precursor, an aerogel-ambigel hybrid material precursor, an aerogel-ambigel-xerogel hybrid material precursor, or combinations thereof.

In some embodiments, the polymer network comprises an aerogel, a xerogel, an ambigel, an aerogel-xerogel hybrid material, an aerogel-ambigel hybrid material, an aerogel-ambigel-xerogel hybrid material, or combinations thereof. In one embodiment, the polymer network comprises a polyimide derivative.

In some embodiments, the polymer network is carbonized.

In some embodiments, the polymer network comprises a carbonized aerogel, a carbonized xerogel, a carbonized ambigel, a carbonized aerogel-xerogel hybrid material, a carbonized aerogel-ambigel hybrid material, a carbonized aerogel-ambigel-xerogel hybrid material, or combinations thereof.

In some embodiments, the polymer network is in the form of a bead. In some embodiments, the bead is substantially spherical, having a diameter from about 100 nm to about 4 mm, or from about 5 μm to about 4 mm.

In some embodiments, the polymer network has a low bulk density, wherein the low bulk density is in the range of about 0.25 g/cc to about 1.0 g/cc.

In some embodiments, the polymer network comprises a skeletal framework comprising nanofibers, wherein the skeletal framework comprising an array of interconnected pores. In some embodiments, the polymer network is a porous polymer network.

In some embodiments, the porous polymer network has a pore volume of at least 0.3 cc/g. In some embodiments, the porous polymer network has a porosity between about 10% and about 90% of a volume of the polymer network. In some embodiments, a pore structure of the porous polymer network includes a pore size at max peak from distribution of about 150 nm or less. In some embodiments, a pore structure of the porous polymer network includes a pore size at max peak from distribution of about 100 nm or less.

In some embodiments, the individual silicon particles within the plurality of silicon particles have a particle diameter in the range of about 50 nm to about 1000 nm. In some embodiments, wherein the individual silicon particles within the plurality of silicon particles have a particle diameter in the range of about 150 nm to about 1000 nm. In some embodiments, wherein the individual silicon particles within the plurality of silicon particles have a particle diameter in the range of about 150 nm to about 800 nm. In some embodiments, wherein the individual silicon particles within the plurality of silicon particles have a particle diameter in the range of about 150 nm to about 500 nm.

In other embodiments, the individual silicon particles within the plurality of silicon particles have a particle diameter of less than 1000 nm, less than 500 nm, less than 300 nm, less than 150 nm. In other embodiments, the individual silicon particles within the plurality of silicon particles have a particle diameter of less than 100 nm.

In some embodiments, the polymer network comprises from about 20% to about 95%, from about 20% to about 65%, from about 30% to about 65%, from about 50% to about 95%, from about 65% to about 95% by weight of the plurality of silicon particles, based on the total weight of the composite material.

In some embodiments, a volume of the plurality of silicon particles comprises between 35% to 60% of a volume of the polymer network.

In some embodiments, individual silicon particles within the plurality of silicon particles are present at least partially within the pore structure of the polymer network.

In some embodiments, the individual silicon particles within the plurality of silicon particles are dispersed heterogeneously throughout the polymer network.

In some embodiments, about 20 wt % to about 50 wt % of the dispersed individual silicon particles within the plurality of silicon particles are in an agglomerated state. In some embodiments, less than about 20 wt % of the dispersed individual silicon particles within the plurality of silicon particles are in an agglomerated state.

In some embodiments, the composite material of the present disclosure is for use in an electrical energy storage system e.g., a battery. In some embodiments, the battery is a rechargeable battery e.g., Li-ion battery.

Provided herein is a rechargeable battery comprising the composite material of the present disclosure.

Provided herein is a method of preparing a composite material, the composite material comprising a polymer network and a plurality of silicon particles, individual silicon particles within the plurality of silicon particles are dispersed throughout the polymer network. In some embodiments, the polymer network is a porous polymer network. The method comprises: (a) providing a plurality of silicon particles; (b) oxidizing a surface of the plurality of the silicon particles to obtain hydroxyl functional groups (or silanol groups) on the surface; (c) covalently reacting hydroxyl functional groups on the surface with molecules including functional groups to obtain covalently attached functional groups on the surface of individual silicon particles within the plurality of silicon particles; (d) providing a sol-gel solution, the sol-gel solution comprising a polar solvent and a precursor of the polymer network; and (e) processing the plurality of silicon particles in the presence of the sol-gel solution to yield a polymer network comprising the plurality of silicon particles, wherein individual silicon particles within the plurality of silicon particles are dispersed throughout the polymer network.

In some embodiments, the method of preparing a composite material of the present disclosure further comprises a step of subcritical or supercritical drying after processing the plurality of silicon particles in the presence of the sol-gel solution. In some embodiments, the molecules in step (c) including functional groups are selected from 3-aminopropyltriethoxysilane (APTES), 3-aminopropyltrimethoxysilane (APTMS), N-(2-aminoethyl)-3-aminopropyltriethoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof.

In some embodiments, individual silicon particles within the plurality of silicon particles are dispersed heterogeneously throughout the polymer network.

In some embodiments, about 20 wt % to about 50 wt % of the dispersed individual silicon particles within the plurality of silicon particles are in an agglomerated state.

In some embodiments, less than about 20 wt % of the dispersed individual silicon particles with the plurality of silicon particles are in an agglomerated state.

The composite materials of the present technology are very promising electrode candidates for efficient lithium storage devices, taking advantage of the high theoretical capacity of dispersed nanosized Si particles throughout the highly stable polymer network, e.g., the porous network of an aerogel.

### BRIEF DESCRIPTION OF THE DRAWINGS

The technology will be more fully understood from the following detailed description taken in conjunction with the accompanying drawings, in which:

FIG. 1A and FIG. 1B show scanning electron microscope (SEM) pictures of AE-APTMES functionalized Si particles (Si particles available from Buhler, Switzerland) dispersed in sol-gel solution before gelation (FIG. 1A) and dispersed in polyimide gel-beads after gelation (FIG. 1B). The sol-gel solution in FIG. 1A comprises a precursor of polyimide (PI) gel.

FIG. 2A and FIG. 2B show scanning electron microscope (SEM) images of the exemplary polymer networks according to multiple embodiments of the present application. FIG. 2A shows an exemplary aerogel network according to multiple embodiments of the present application. FIG. 2B shows an exemplary xerogel network according to multiple embodiments of the present application.

FIG. 3 shows an exemplary preparation scheme for functionalization of Si particles of the present disclosure.

FIG. 4 shows infrared radiation (IR) spectra of pristine, oxidized and surface modified Evonik a-Si particles.

FIG. 5A, FIG. 5B and FIG. 5C show scanning electron microscope (SEM) images of pristine Si particles in the sol (FIG. 5A), polyimide beads including pristine Si particles in the sol (FIG. 5B) and carbonized polyimide beads (Si/C beads) including AEAPTMS functionalized Si particles (on a carbon tape) (FIG. 5C).

FIG. 6A, FIG. 6B and FIG. 6C show scanning electron microscope (SEM) images AEAPTMS functionalized Si particles in the sol (FIG. 6A), polyimide beads including AEAPTMS functionalized Si particles in the sol (FIG. 6B) and carbonized polyimide beads (carbon beads) including AEAPTMS functionalized Si particles (on a carbon tape) (FIG. 6C).

FIG. 7A and FIG. 7B show cross-section SEM images of carbon beads with well dispersed silicon particles.

FIG. 8 shows a particle size distribution histogram of Si/C particles.

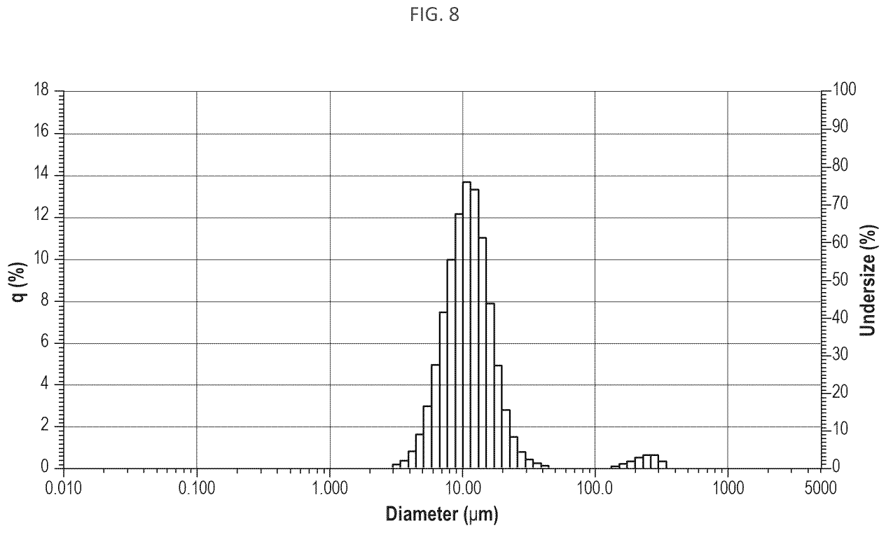

FIG. 9 shows thermal gravimetric analysis (TGA) curve 800, differential scanning calorimetry (DSC) curve 820 of Si/C particles, and corresponding temperature ramp curve 810. A ramp up rate of 20° C./min was used until 550° C., then the temperature was held at 550° C. for 4 h, and the sample was tested in air.

### DETAILED DESCRIPTION

Silicon (Si) is considered to be a promising alternative LIB anode material. It forms Li₇Si₃, Li₁₂Si₇, Li₁₃Si₄, Li₁₅Si₄, and Li₂₂Si₅ silicon-lithium alloys during the alloying process, among which Li₁₅Si₄ has a capacity of 3579 mAh g⁻¹ (2194 Ah L⁻¹) at room temperature, which is the highest theoretical capacity known for the anode material. Therefore, incorporating as much silicon as possible within the anode is desirable. The Si mass loading of the covalently functionalized Si particles of the present disclosure to the anode may be higher than the Si particles which do not possess the covalently functionalized Si particles of the present disclosure e.g., non-functionalized silicon particles. Without wishing to be bound by theory, improved dispersion of the covalently functionalized silicon particles of the present disclosure relative to non-functionalized silicon particles may increase Si mass loading to the high-capacity batteries.

At the same time, the average voltage platform of Si (0.4 V vs. Li/Li⁺) is higher than that of the graphite electrode (0.125 V vs. Li/Li⁺), which makes it possible to avoid lithium plating and dendritic lithium formation on the anode material surface during the lithiation process. As a result, the safety performance of the battery can be significantly improved. Also, Si has the advantages of abundant reserves in the earth's crust and low price, which fosters further the industrial interest to utilize silicon in batteries.

Despite these advantages, silicon still has severe shortcomings when used as an electrode material. The core problem for the utilization of Si in a LIB is its vast volume expansion during lithiation. Silicon electrodes can expand by up to 400%, which is much more than the 10% for graphite electrodes. First, Si particles are gradually pulverized due to the repeated volume change and lose electrical contact between the active and other components, including conductive carbon and binder, which causes the capacity to decrease sharply and the cycle performance to decline rapidly. Secondly, the volume change also gradually causes active material to peel off the current collector, resulting in an electrical contact loss between the active material and the current collector, and the electrode capacity reduction after the initial cycle. Besides, the solid electrolyte interphase (SEI) layer is fractured and reformed continuously due to the volume expansion/contraction behavior of the Si electrode during cycling, resulting in the continuous exposure of fresh Si surface to the electrolyte. As a result, electrolyte degradation takes place continually on the highly reducing fresh lithiated Si surface, thus leading to an irreversible capacity loss at each cycle and eventual cell death. Both the mechanical failure and the electrolyte degradation can make the Si electrode lose its electrochemical activity very rapidly in the cycling process.

A composite material of the present disclosure comprises: a plurality of silicon particles, wherein a surface of the plurality of the silicon particles includes covalently attached functional groups selected from —OH, —COOH, —C—O—C—, —NH₂, —NHR, or combinations thereof; and a polymer network, wherein individual silicon particles within the plurality of silicon particles are dispersed throughout the polymer network.

The composite materials provided herein obviate or mitigate at least one disadvantage of Si when used as an electrode material. Without wishing to be bound by theory, in general, the composite particles provided herein may be able to accommodate changes in volume of the active Si material during battery operation.

In the description below, several examples are provided in the context of lithium-ion batteries because of the current prevalence and popularity of Li-ion technology. However, it will be appreciated that such examples are provided merely to aid in the understanding and illustration of the underlying techniques, and that these techniques may be similarly applied to various other metal-ion batteries, such as Li⁺, Na⁺, Mg²⁺, Ca²⁺, and Al³⁺, and other metal-ion batteries. The composite material of the present disclosure can be used in other battery chemistries where active particles undergo significant volume changes during their operation (e.g., reversible reduction-oxidation reactions), including, for example, aqueous electrolyte-containing batteries.

### Definitions

The articles “a” and “an” are used herein to refer to one or to more than one (i.e., to at least one) of the grammatical object of the article.

Within the context of the present disclosure, the term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Within the context of the present disclosure, the term “aerogel” or “aerogel material” refers to a solid object, irrespective of shape or size, comprising a framework of interconnected solid structures, with a corresponding network of interconnected pores integrated within the framework, and containing gases such as air as a dispersed interstitial medium. As such, aerogels are open non-fluid colloidal or polymer networks that are expanded throughout their whole volume by a gas. Aerogels are generally prepared by removing the solvent from a gel (a solid network that contains a solvent) in a manner such that minimal or no contraction of the gel can be brought by capillary forces at its pore walls, in other words, by the removal of all swelling agents from a corresponding wet-gel without substantial volume reduction or network compaction. Methods of solvent removal include, but are not limited to, supercritical drying (or drying using supercritical fluids, such that the low surface tension of the supercritical fluid exchanges with the transient solvent within the gel), exchange of solvent with supercritical fluid, exchange of solvent with fluid that is subsequently transformed to the supercritical state, sub- or near-critical fluid drying, and sublimating a frozen solvent in a freeze-drying process. See for example, PCT Patent Application Publication No. WO2016127084A1.

Aerogels include a highly porous network of micro-, meso-, and macro-sized pores, and are generally characterized by the following physical and structural properties (according to nitrogen porosimetry testing and helium pycnometry) attributable to aerogels: (a) an average pore diameter ranging from about 2 nm to about 100 nm; (b) a porosity of at least 60% or more, and (c) a specific surface area of about 100 m²/g or more, such as from about 100 to about 1000 m²/g by nitrogen sorption analysis.

Aerogel materials of the present disclosure thus include any aerogels or other open-celled compounds, which satisfy the defining elements set forth in previous paragraphs.

As used herein, the terms “xerogel” and “ambigel” refer to gels comprising an open, non-fluid colloidal or polymer network that is formed by the removal of all swelling agents from a corresponding wet-gel without any precautions taken to avoid substantial volume reduction or compaction, such as under ambient pressure drying. In contrast to an aerogel, a xerogel, such as a silica xerogel, generally comprises a compact structure. Xerogels experience substantial volume reduction during ambient pressure drying, and can have lower surface areas compared to aerogels, such as 0-100 m²/g, or from about 0 to about 20 m²/g as measured by nitrogen sorption analysis.

Within the context of the present disclosure, the term “continuous” refers to a layer free of gaps, holes, or any discontinuities. For example, a continuous layer that does not include two (or more) component materials physically separated (or spaced apart) within this layer.

As used herein, the term “uniform” refers to a variation in the thickness of a material e.g. the coating of the present disclosure of less than about 10%, less than about 5%, or less than about 1%.

Within the context of the present disclosure, the term “capacity” refers to the amount of specific energy or charge that a battery is able to store. Capacity is specifically measured as the discharge current that the battery can deliver over time, per unit mass. It is typically provided as Ampere-hours or milliAmpere-hours per gram (Ah/g or mAh/g) of total active material mass. For example, a battery with 1 Ah capacity can supply a current of one ampere for one hour or 0.5 amps for two hours, etc. Therefore, 1 Ampere-hour (Ah) is the equivalent of 3,600 coulombs of electrical charge. Similarly, the term “milliampere-hour (mAh)” also refers to a unit of the storage capacity of a battery and is 1/1,000 of an Ampere-hour. The capacity of a battery (and an anode in particular) may be determined by methods known in the art, for example including, but not limited to: applying a fixed constant current load to a fully charged cell until the cell's voltage reaches the end of discharge voltage value; the time to reach end of discharge voltage multiplied by the constant current is the discharge capacity; by dividing the discharge capacity by the weight of electrode material or volume. Within the context of the present disclosure, measurements of capacity are acquired according to this method, unless otherwise stated. Unless otherwise noted, capacity is reported at cycle 10 of the battery.

As used herein, the term “electrode” refers to a “cathode” or an “anode.” As used herein, the term “positive electrode” is used interchangeably with cathode. Likewise, the term “negative electrode” is used interchangeably with anode.

Within the context of the present disclosure, the terms “framework” or “framework structure” refer to the network of interconnected oligomers, polymers, or colloidal particles that form the solid structure of a gel or an aerogel. The polymers or particles that make up the framework structures typically have a diameter of about 100 Angstroms. However, framework structures of the present disclosure can also include networks of interconnected oligomers, polymers, or colloidal particles of all diameter sizes that form the solid structure within a gel or aerogel.

### The Composite Material

In some embodiments, a composite material comprises: a plurality of silicon particles, wherein a surface of the plurality of the silicon particles includes covalently attached functional groups; and a polymer network, wherein individual silicon particles within the plurality of silicon particles are dispersed throughout the polymer network. In some embodiments, the polymer network is a porous polymer network.

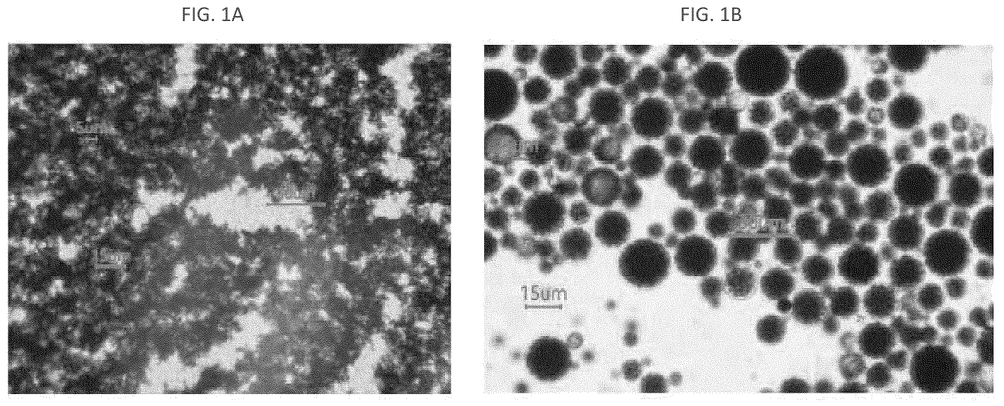

Within the context of the present disclosure, the term “dispersion” refers to a dispersion in which one substance, which is the dispersed phase, is distributed in discrete units throughout the second substance (continuous phase or medium). In general, the dispersed phase is not substantially agglomerated, but rather spaced within the second substance. While dispersion includes the gathering or touching of a few particles (e.g., two, three, four, less than five), the particles are generally spaced evenly throughout the second substance, such as that shown in FIG. 1A and FIG. 1B.

Generally, the silicon is contained at least partially within the pores of the polymeric network, i.e., the silicon is disposed within the framework of the polymeric network. The silicon accepts lithium ions during charge and releases lithium ions during discharge. In certain embodiments, the polymeric network forms interconnected structures around the silicon, which is connected to the polymeric network at a plurality of points.

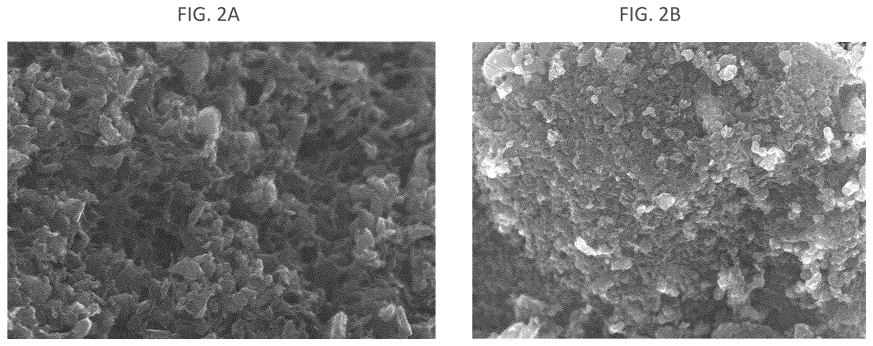

In contrast to an aerogel (FIG. 2A), a xerogel, such as a silica xerogel, generally comprises a compact structure (FIG. 2B). Xerogels experience substantial volume reduction during ambient pressure drying, and can have lower surface areas compared to aerogels, such as 0-100 m²/g, or from about 0 to about 20 m²/g as measured by nitrogen sorption analysis. In addition, as shown in FIG. 2A and FIG. 2B, xerogels have a more densely packed fibrillar morphology compared to aerogels. Within the context of the present disclosure, the term “fibrillar morphology” refers to the structural morphology of a nanoporous material (e.g., a carbon aerogel) being inclusive of struts, rods, fibers, or filaments.

### Measurement of Composite Material Properties

The composite materials can be characterized by properties such as pore volume, porosity, surface area, and pore size distribution. These properties and associated terms are defined herein below, along with methods of measuring and/or calculating such properties.

Within the context of the present disclosure, the term “pore volume” refers to the total volume of pores within a sample of porous material. Pore volume is specifically measured as the volume of void space within the porous material, where that void space may be measurable and/or may be accessible by another material, for example an electrochemically active species such as silicon particles. It is typically recorded as cubic centimeters per gram (cm³/g or cc/g).

Within the context of the present disclosure, the term “porosity” when used with respect to the polymeric network or the composite materials disclosed herein, refers to a volumetric ratio of pores that does not contain another material (e.g., an electrochemically active species such as silicon particles) bonded to the walls of the pores. For clarification and illustration purposes, it should be noted that within the specific implementation of silicon-doped polymeric network e.g., an aerogel as the primary anodic material in a LIB, porosity refers to the void space after inclusion of silicon particles. As such, porosity may be, for example, about 10%-70% when the anode is in a pre-lithiated state (to accommodate for ion transport and silicon expansion) and about 1%-50% when the anode is in a post-lithiated state. It should be noted that pore volume and porosity are different measures for the same property of the pore structure, namely the “empty space” within the pore structure. For example, when silicon is used as the electrochemically active species contained within the pores of the polymeric network (e.g., a composite material as described herein), pore volume and porosity refer to the space that is “empty”, namely the space not utilized by the silicon or the carbon.

Within the context of the present disclosure, the term “pore size distribution” refers to the statistical distribution or relative amount of each pore size within a sample volume of a porous material. A narrower pore size distribution refers to a relatively large proportion of pores at a narrow range of pore sizes, thus optimizing the amount of pores that can surround the electrochemically active species and maximizing use of the pore volume. Conversely, a broader pore size distribution refers to relatively small proportion of pores at a narrow range of pore sizes. As such, pore size distribution is typically measured as a function of pore volume and recorded as a unit size of a full width at half max of a predominant peak in a pore size distribution chart.

Within the context of the present disclosure, the term “pore size at max peak from distribution” refers to the value at the discernible peak on a graph illustrating pore size distribution. Pore size at max peak from distribution is specifically measured as the pore size at which the greatest percentage of pores is formed. It is typically recorded as any unit length of pore size, for example micrometers or nanometers (nm).

Within the context of the present disclosure, the term “BET surface area” has its usual meaning of referring to the Brunauer-Emmett-Teller method for determining surface area by N₂ adsorption measurements. The BET surface area, expressed in m²/g, is a measure of the total surface area of a porous material per unit of mass. Unless otherwise stated, “surface area” refers to BET surface area. As an alternative to BET surface area, a geometric outer surface area of e.g., a polyimide or carbon bead may be calculated based on the diameter of the bead. Generally, such geometric outer surface areas for beads of the present disclosure are within a range from about 3 to about 700 μm².

As used herein, the term “particle size D50” which is a volume-based accumulative 50% size which is a particle size at a point of 50% on an accumulative curve (i.e., a diameter of a particle in the 50th percentile (median) of the volumes of particles) when the accumulative curve is drawn so that a particle size distribution is obtained on the volume basis and the whole volume is 100%.

Within the context of the present disclosure, the term “density” refers to a measurement of the mass per unit volume of a material (e.g., a composite material as described herein). The term “density” generally refers to the true or skeletal density of a material, as well as to the bulk density of a material or composition. Density is typically reported as g/cm³, g/cc, or g/mL.

The composite material properties can be determined using mercury intrusion porosity and helium pycnometry experiments. Mercury intrusion porosity can be used to determine porosity, pore size distribution and pore volume to solid particles. During a typical mercury intrusion porosity, a pressurized chamber is used to force mercury into the voids in a porous substrate. As pressure is applied, mercury fills the larger pores first. As the pressure increases, the mercury can enter into smaller pores. The mercury pycnometry can access and measure pores greater than about 3 nm. Mercury intrusion porosity can be used measure bulk density, skeletal density and porosity. By varying testing parameters (e.g., the pressure range), pores with different sizes can be excluded. The lower pore size limit if mercury intrusion porosity is about 3 nm.

Helium pycnometry uses helium gas to measure the volume of pores of a solid material. During helium pycnometry, a sample is sealed in a compartment and helium gas is added to the compartment. The helium gas penetrates into small pores in the material. After the system has equilibrated, the change in pressure can be used to determine the skeletal density of the solid material. The Helium pycnometry can access and measure pores greater than about 0.3 nm, for example, pores sizing from about 3 nm to about 300 nm.

The “Hg skeletal density” (g/cm³) is measured by dividing the mass (g) of the composite material particles by the volume (cm³) of the particles, where the volume is measured by controlling (e.g., by pressure) the mercury access to pores of the particles greater than 3 nm during the measurement. This volume does not include the volume of the mercury accessible pores of the composite materials greater than 3 nm. Instead, the volume only includes the volume of the “skeleton” of the composite material particles. The volume of the pores less than 3 nm is considered as part of the skeleton and included in the skeletal density calculation.

The “Hg bulk density” is measured by dividing the mass (g) of the composite material particles by the volume (cm³) of the particles, where the volume is measured by controlling (e.g., by pressure) the mercury not to access pores of the particles during the measurement. This volume includes the volume of the pores of the composite materials, including pores greater than 3 nm and less than 3 nm.

The “He skeletal density” is measured by dividing the mass (g) of the composite material particles by the volume (cm³) of the particles, where the volume is measured by controlling (e.g., by pressure) the helium to access pores of the particles greater than 0.3 nm during the measurement. This volume does not include the volume of the helium accessible pores of the composite materials greater than 0.3 nm. Instead, the volume only includes the volume of the “skeleton” of the composite material particles. The volume of the pores less than 0.3 nm is considered as part of the skeleton and included in the skeletal density calculation.

The composite material may also include pores not accessible to either helium nor mercury during the helium pycnometry or mercury pycnometry tests. For example, some of pores formed by removing sacrificial particles may be enclosed in the three-dimensional network and therefore accessible to neither helium pycnometry nor the mercury pycnometry. These non-accessible pores are usually a very small amount in the composite materials disclosed herein. The non-accessible pores are treated as part of the volume of the skeleton without introducing significant variations.

Various physical properties can be calculated according to the formulas below using mercury (Hg) intrusion skeletal density measurements (Hg skeletal density) measured by mercury pycnometry, mercury intrusion bulk density (Hg bulk density) measured by mercury pycnometry, and helium (He) skeletal density (He skeletal density) tested by He pycnometry.

$$Total beads level porosity ( \% ) = \{ ( 1 - \frac{Hg bulk density}{He skeletal density} ) / 1 \} * 100 \qquad ( 1 )$$

$$Total pore volume ( {cm}^{3} / g ) = \frac{1}{Hg bulk density} * \frac{Total beads level porosity}{100} \qquad ( 2 )$$

$$Micropore volume ( {cm}^{3} / g ) = \frac{1}{Hg skeletal density} - \frac{1}{He skeletal density} \qquad ( 3 )$$

$$Micropore volume percentage ( \% , vs total pore volume ) = micropore volume / total pore volume \qquad ( 4 )$$

$$Mesopore volume percentage ( \% , vs total pore volume ) can be obtained through the mercury intrusion by excluding all the pores > 50 nm$$

$$Macropore volume percentage ( \% , vs total pore volume ) = 1 - micropore volume percentage - mesopore volume percentage \qquad ( 5 )$$

The “total beads level porosity” (%) refers to the ratio of the volume of the pores in the composite material particles to the volume of the composite material particles. The total beads level porosity is calculated by equation (1). The total beads level porosity includes pores of greater than 0.3 nm that can be accessed by helium and mercury.

The “total pore volume” (cm³/g) refers to the total pore volume of unit weight of the composite material particles. The total pore volume is calculated by equation (2). The total pore volume includes pores greater than 0.3 nm that can be accessed by helium and mercury.

The “micropore volume” (cm³/g) refers to the micropore volume of unit weight of the composite material particles. The micropore volume (cm³/g) of the composite material is the difference between of the reciprocal (cm³/g) of the mercury skeletal density (g/cm³) and the reciprocal (cm³/g) of the helium skeletal density (g/cm³) according to equation (3). The micropore volume includes pores greater than 0.3 nm but less than 3 nm. The micropores are accessible by helium but not accessible by mercury.

The “micropore volume percentage” (%) refers to the volumetric ratio between the volume of the micropore to the total pore volume. The micropore volume percentage is calculated by equation (4).

The “mesopore volume percentage” (%) refers to the volumetric ratio between the volume of the mesopores to the total pore volume. Mesopores refers to pores between about 3 nm to about 50 nm that are accessible by mercury. Pores below 3 nm are not accessible by mercury. Mesopore volume percentage can be directly measured using mercury pycnometry by excluding pores greater than 50 nm. The mesopore volume percentage can also be obtained by subtracting micropore volume percentage (calculated in equation (4)) and macropore volume percentage (measured by mercury pycnometry) from total pore volume percentage (100%).

The “macropore volume percentage” (%) refers to the volumetric ratio between the volume of the macropores to the total pore volume. Macropores are greater than about 50 nm that are accessible by mercury. Macropore volume percentage can be directly measured using mercury pycnometry by excluding pores smaller than 50 nm. The macropore volume percentage can also be obtained by subtracting micropore volume percentage (calculated in equation (4)) and mesopore volume percentage (measured by mercury pycnometry) from total pore volume percentage (100%).

### Composite Material Properties

### Total Porosity

Composite materials described herein generally include micropores (<3 nm), mesopores (3 nm-50 nm), and macropores (>50 nm). The composite materials described herein include a three-dimensional carbon network having a substantial amount of macropores. In some aspects, the total level of porosity of the three-dimensional carbon network is greater than 10%, greater than 20%, greater than 30%, greater than 40%, greater than 50%, greater than 60%, or greater than 70%. In some aspects, the total level of porosity of the three-dimensional carbon network is 25% to 35%, 30% to 40%, 35% to 45%, 40% to 50%, 55% to 65%, or 60% to 70%.

In certain embodiments, aerogel materials or composite materials of the present disclosure have a bead level porosity of about 80% or less, 70% or less, 60% or less, 50% or less, 40% or less, 30% or less, 20% or less, 10% or less, or in a range between any two of these values.

### Total Pore Volume

In some aspects, aerogel materials or compositions of the present disclosure (without incorporation of electrochemically active species, e.g., silicon) have a relatively large total pore volume of about 1 cc/g or more, 1.5 cc/g or more, 2 cc/g or more, 2.5 cc/g or more, 3 cc/g or more, 3.5 cc/g or more, 4 cc/g or more, or in a range between any two of these values. In other embodiments, aerogel materials or compositions of the present disclosure (with incorporation of electrochemically active species, e.g., silicon) have a pore volume of about 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values. In further aspects, the total pore volume of the composite material (with incorporation of electrochemically active species, e.g., silicon) is from about 0.1 cm³/g to about 1.5 cm³/g, about 0.1 cm³/g to about 1.0 cm³/g, about 0.1 cm³/g to about 0.5 cm³/g, about 0.1 cm³/g to about 0.4 cm³/g, about 0.4 cm³/g to about 1.0 cm³/g, or about 0.9 cm³/g to about 1.4 cm³/g.

### Pore Size Distribution

In certain aspects, aerogel materials or compositions of the present disclosure have a pore size at max peak from distribution of about 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, 10 nm or less, 5 nm or less, 2 nm or less, or in a range between any two of these values.

In certain aspects, aerogel materials or compositions of the present disclosure have a relatively narrow pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values.

### Macropores, Mesopores, and Micropores

In some aspects, the macropores constitute a volume fraction of greater than about 5%, greater than about 10%, greater than about 20%, greater than about 30%, greater than about 40%, greater than about 50%, greater than about 60%, greater than about 70%, or greater than about 80% of the total pore volume of the three-dimensional carbon network. In some aspects, the macropores constitute a volume fraction of 45% to 55%, 55% to 65%, 65% to 75%, or 70% to 80% of the total pore volume of the three-dimensional carbon network. The composite materials described herein generally have a low volume fraction of mesopores. In some aspects, the mesopores constitute a volume fraction of less than 20%, less than 10%, less than 5%, less than 2%, or less than 1% of the total pore volume of the three-dimensional carbon network. In some aspects, the mesopores constitute a volume fraction of 10% to 20%, 5% to 10%, or 1% to 5% of the total pore volume of the three-dimensional carbon network.

The composite materials described herein include a higher percentage of micropores compared to mesopores. In some aspects, the micropores constitute a volume fraction of less than 80%, less than 70%, less than 65%, less than 55%, less than 50%, less than 45%, less than 40%, less than 35%, less than 30%, less than 25%, less than 20%, less than 15%, or less than 10% of the total pore volume of the three-dimensional carbon network. In some aspects, the micropores constitute a volume fraction of about 10% to about 50%, about 10% to about 45%, about 10% to about 40%, about 10% to about 35%; about 10% to about 30%, about 10% to about 25%, about 10% to about 20%, about 10% to about 15%, about 15% to about 25%, about 25% to about 35%, about 35% to about 45%, or about 45% to about 55% of the total pore volume of the three-dimensional carbon network.

### Skeletal Density

In some aspects, the composite materials have a skeletal density, measured using helium pycnometry, of about 1.0 g/mL to about 2.5 g/mL, about 1.5 g/mL to about 2.5 g/mL, about 1.0 g/mL to about 2.0 g/mL, or 1.0 g/mL to about 1.5 g/mL. In some aspects, the composite materials have a skeletal density, measured using mercury intrusion, of about 0.5 g/mL to about 2.5 g/mL, about 1.5 g/mL to about 2.5 g/mL, about 1.5 g/mL to about 2.0 g/mL, about 0.5 g/mL to about 2.0 g/mL, about 0.5 g/mL to about 1.5 g/mL, or about 0.5 g/mL to about 1.0 g/mL. In some aspects, the composite materials have a bulk density, measured using mercury pycnometry, of 0.5 g/mL to about 2.5 g/mL, of 0.5 g/mL to about 2.0 g/mL, about 0.5 g/mL to about 1.5 g/mL, or about 0.5 g/mL to about 1.0 g/mL.

Preferably, aerogel materials or composite materials of the present disclosure have a tap density of about 1.50 g/cc or less, about 1.40 g/cc or less, about 1.30 g/cc or less, about 1.20 g/cc or less, about 1.10 g/cc or less, about 1.00 g/cc or less, about 0.90 g/cc or less, about 0.80 g/cc or less, about 0.70 g/cc or less, about 0.60 g/cc or less, about 0.50 g/cc or less, about 0.40 g/cc or less, about 0.30 g/cc or less, about 0.20 g/cc or less, about 0.10 g/cc or less, or in a range between any two of these values, for example between about 0.15 g/cc and 1.5 g/cc or more particularly 0.50 g/cc and 1.30 g/cc.

In some embodiments, the composite material of the present disclosure comprises a low bulk density material. In some embodiments, the low bulk density material comprises a skeletal framework comprising nanofibers, the skeletal framework forming a pore structure comprising an array of interconnected pores. In some embodiments, such materials may have a fibrillar morphology. In some embodiments, the composite material is an aerogel, a xerogel, a cryogel, or an ambigel, or combination thereof. In some embodiments, the composite material is an aerogel.

Structurally, some embodiments of the carbonized network have a fibrillar morphology with a strut size that produces the aforementioned narrow pore size distribution, porosity, and enhanced connectedness, among other properties. In any embodiment, the fibrillar morphology of the carbon material can include an average strut width of about 2-10 nm, or even more specifically about 2-5 nm.

Within the context of the present disclosure, the term “strut width” refers to the average diameter of nanostruts, nanorods, nanofibers, or nanofilaments that form a material having a fibrillar morphology. It is typically recorded as any unit length, for example micrometers or nm. The strut width may be determined by methods known in the art, for example including, but not limited to, scanning electron microscopy image analysis. Within the context of the present disclosure, measurements of strut width are acquired according to this method, unless otherwise stated. In certain embodiments, materials or compositions of the present disclosure have a strut width of about 10 nm or less, 9 nm or less, 8 nm or less, 7 nm or less, 6 nm or less, 5 nm or less, 4 nm or less, 3 nm or less, 2 nm or less, or in a range between any two of these values. An exemplary range of strut widths is about 2-5 nm. Smaller strut widths, such as these, permit a greater amount of struts to be present within the network and thus contact the electrochemically active species, in turn allowing more of the electrochemically active species to be present within the composite. This increases electrical conductivity and mechanical strength.

### Method of Preparing a Composite Material

Provided herein is a method of preparing a composite material, the composite material comprising a polymer network and a plurality of silicon particles, individual silicon particles within the plurality of silicon particles are dispersed throughout the polymer network, the method comprising: (a) providing a plurality of silicon particles; (b) oxidizing a surface of the plurality of the silicon particles to obtain hydroxyl functional groups (or silanol groups) on the surface; (c) covalently reacting hydroxyl functional groups on the surface with molecules including functional groups to obtain covalently attached functional groups on the surface of individual silicon particles within the plurality of silicon particles; (d) providing a sol-gel solution, the sol-gel solution comprising a polar solvent and a precursor of the polymer network; (e) processing the plurality of silicon particles in the presence of the sol-gel solution to yield a polymer network comprising the plurality of silicon particles, wherein individual silicon particles within the plurality of silicon particles are dispersed throughout the polymer network. In some embodiments, the polymer network is a porous polymer network.

Oxidizing a surface of the plurality of the silicon particles may comprise an acid treatment step. In some embodiments, the acid treatment step comprises the use of sulphochromic acid or H₂O₂ (hydrogen peroxide). In some examples, the acid treatment step comprises a step of sonicating the plurality of the silicon particles for a certain period of time, e.g., at least 5 minutes, at least 10 minutes, at least 20 minutes, at least 30 minutes, or at least 60 minutes. Oxidizing a surface of the plurality of the silicon particles may comprise a step of pyrolysis at a temperature about at 300, about 400, or about 500, to about 600, about 650, about 700, about 800, or about 900° C. In some embodiments, the temperature is about 650° C. As used herein, the term “pyrolyze” or “pyrolysis” refers to the decomposition or transformation of an organic compound or composition to pure or substantially pure carbon caused by heat. Oxidizing a surface of the plurality of the silicon particles may lead to increase in the number of Si—O or Si—OH bonds on the surface of the silicon particles.

In some embodiments, the method of preparing a composite material of the present disclosure further comprises a step of subcritical or supercritical solvent removal, e.g., drying, after processing the plurality of silicon particles in the presence of the sol-gel solution. Methods of solvent removal include, but are not limited to, supercritical drying (or drying using supercritical fluids, such that the low surface tension of the supercritical fluid exchanges with the transient solvent within the gel), exchange of solvent with supercritical fluid, exchange of solvent with fluid that is subsequently transformed to the supercritical state, sub- or near-critical fluid drying, and sublimating a frozen solvent in a freeze-drying process. See for example, PCT Patent Application Publication No. WO2016127084A1.

### The Polymer Network

In some embodiments, the polymer network is a sol-gel solution. In one or more embodiments, the sol-gel solution comprises an aerogel precursor, a xerogel precursor, an ambigel precursor, an aerogel-xerogel hybrid material precursor, an aerogel-ambigel hybrid material precursor, an aerogel-ambigel-xerogel hybrid material precursor, or combinations thereof.

In some embodiments, the polymer network is a three-dimensional network. In some embodiments, the polymer network is a porous polymer network.

In some embodiments, the polymer network comprises an aerogel, a xerogel, an ambigel, an aerogel-xerogel hybrid material, an aerogel-ambigel hybrid material, an aerogel-ambigel-xerogel hybrid material, or combinations thereof.

Aerogel materials of the present disclosure can include any aerogels or other open-celled compounds, which satisfy the defining elements set forth in previous paragraphs, including compounds, which can be otherwise categorized as xerogels, cryogels, ambigels, microporous materials, and the like.

To further expand on the exemplary application within LIBs, when aerogel material is used as the primary electrode material e.g., anodic material as in examples of this present disclosure, the aerogel porous core has a narrow pore size distribution, and provides for high electrical conductivity, high mechanical strength, and a morphology and sufficient pore volume (at a final density) to accommodate a high percentage by weight of silicon particles and expansion thereof.

In some examples, the surface of the polymeric network may be modified via chemical, physical, or mechanical methods in order to enhance performance with electrochemically active species contained within the pores of the polymeric network.

Furthermore, it is contemplated herein that the polymeric network, and specifically aerogels, can take the form of monolithic structures. When monolithic in nature, the carbon aerogel eliminates the need for any binders; in other words, the anode can be binder-less. As used herein, the term “monolithic” refers to aerogel materials in which a majority (by weight) of the aerogel included in the aerogel material or composition is in the form of a unitary, continuous, interconnected aerogel nanostructure. Monolithic aerogel materials include aerogel materials which are initially formed to have a unitary interconnected gel or aerogel nanostructure, but which can be subsequently cracked, fractured or segmented into non-unitary aerogel nanostructures. Monolithic aerogels may take the form of a freestanding structure or a reinforced (fiber or foam) material. In comparison, using silicon lithiation as an example, silicon incorporated into a monolithic aerogel can be utilized more effectively relative to theoretical capacity, as compared to the same amount of silicon incorporated into a slurry using conventional processes.

Monolithic aerogel materials are differentiated from particulate aerogel materials. The term “particulate aerogel material” refers to aerogel materials in which a majority (by weight) of the aerogel included in the aerogel material is in the form of particulates, particles, granules, beads, or powders, which can be combined together (i.e., via a binder, such as a polymer binder) or compressed together but which lack an interconnected aerogel nanostructure between individual particles. Collectively, aerogel materials of this form will be referred to as having a powder or particulate form (as opposed to a monolithic form). It should be noted that despite an individual particle of a powder having a unitary structure, the individual particle is not considered herein as a monolith. Integration of aerogel powder into an electrochemical cell typically preparation of a paste or slurry from the powder, casting and drying onto a substrate, and may optionally include calendaring.

Particulate aerogel materials, e.g., aerogel beads, provide certain advantages. For example, particulate materials can be used as a direct replacement for other materials such as graphite in LIB anodes and anode manufacturing processes. Particulate materials can also provide improved lithium-ion diffusion rates due to shorter diffusion paths within the particulate material. Particulate materials can also allow for electrodes with enhanced packing densities, e.g., by tuning the particle size and packing arrangement. Particulate materials can also provide improved access to silicon due to inter-particle and intra-particle porosity.

Aerogels can be formed of inorganic materials, organic materials, or mixtures thereof. When formed of organic materials such as, for example, phenols, resorcinol-formaldehyde (RF), phloroglucinol-furfuraldehyde (PF), polyacrylonitrile (PAN), polyamic acid (PAA), polyimide (PI), polyurethane (PU), polyurea (PUA), polyamine (PA), polybutadiene, polydicyclopentadiene, and precursors or polymeric derivatives thereof.

### Inorganic Aerogels

Inorganic aerogels are generally formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxylsilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain embodiments of the present disclosure, pre-hydrolyzed TEOS, such as Silbond H-5 (SBH5, Silbond Corp), which is hydrolyzed with a water/silica ratio of about 1.9-2, may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

Aerogels may also be treated to impart or improve hydrophobicity. Hydrophobic treatment can be applied to a sol-gel solution, a wet-gel prior to liquid extraction, or to an aerogel subsequent to liquid extraction. Hydrophobic treatment is especially common in the production of metal oxide aerogels, such as silica aerogels. Hydrophobic treatment is carried out by reacting a hydroxy moiety on a gel, such as a silanol group (Si—OH) present on a framework of a silica gel, with a functional group of a hydrophobizing agent. The resulting reaction converts the silanol group and the hydrophobizing agent into a hydrophobic group on the framework of the silica gel. The hydrophobizing agent compound can react with hydroxyl groups on the gel according the following reaction: RNMX4-N (hydrophobizing agent)+MOH (silanol)→MOMRN (hydrophobic group)+HX. Hydrophobic treatment can take place both on the outer macro-surface of a silica gel, as well as on the inner-pore surfaces within the porous network of a gel.

### Organic Aerogels

Organic aerogels are generally formed from carbon-based polymeric precursors. Such polymeric materials include, but are not limited to resorcinol formaldehydes (RF), polyamic acid, polyimide, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one example, organic RF aerogels are typically made from the sol-gel polymerization of resorcinol or melamine with formaldehyde under alkaline conditions.

In certain embodiments, aerogels of the present disclosure comprise a polyamic acid, a polyimide, or combination thereof, or a carbon aerogel obtained from a polyamic acid or polyimide by carbonization. In particular embodiments, the aerogel comprises or is obtained by pyrolysis of a polyamic acid, a polyimide, or combination thereof, and the polyamic acid, or polyimide is prepared in an aqueous solution (i.e., via an aqueous sol-gel process). Reference herein to an aqueous solution or aqueous sol-gel process means that the solution or aqueous sol-gel process is substantially free of any organic solvent. The term “substantially free” as used herein in the context of organic solvents means that no organic solvent has been intentionally added, and no organic solvent is present beyond trace amounts. For example, in certain embodiments, an aqueous solution can be characterized as having less than 1% by volume of organic solvent, or less than 0.1%, or less than 0.01%, or even 0% by volume of organic solvent.

Utilization of an aqueous sol-gel process is advantageous in providing rapid gelation, making the process amenable to configuration in a continuous process, for example, for preparing polyimide beads. Aqueous sol-gel processes for preparing polyamic acid and polyimide gel materials are economically preferable to conventional methods of such materials (e.g., expensive organic solvents are avoided, and disposal costs are minimized) and “green” (i.e., beneficial from an environmental standpoint, as potentially toxic organic solvents are avoided and production of toxic byproducts is minimized or eliminated), and are advantageous in potentially reducing the overall number of operations which must be performed to provide carbon or polyamic acid/polyimide gel materials. As disclosed in International Patent Application Publication No. WO2022/125835, and International Patent Application PCT/US2023/016821, each of which is incorporated by reference herein in their entirety, polyamic acid and polyimide gels can be prepared in water, in monolithic or bead form, the gels may be converted to aerogels, which possess nanostructures with similar properties to aerogels prepared by a conventional organic solvent-based process, and the aerogels optionally pyrolyzed to form a corresponding carbon aerogel.

In some embodiments, the aerogel of the present disclosure is a polyamic acid aerogel, in monolithic or bead form, wherein the polyamic acid is prepared by acidification of an aqueous solution of a polyamic acid. In some embodiments, the polyamic acid is dissolved in water in the presence of a base (e.g., an alkali metal hydroxide or non-nucleophilic amine base). In other embodiments, the polyamic acid is prepared in situ under aqueous conditions, directly forming the polyamic acid salt solution. In some embodiments, the polyamic acid is any commercially available polyamic acid. In other embodiments, the polyamic acid has been previously formed (“pre-formed”) and isolated, e.g., prepared by reaction of a diamine and a tetracarboxylic dianhydride in an organic solvent according to conventional synthetic methods. In some embodiments, the aqueous solution of a polyamic acid salt is prepared in situ by e.g., reaction of a diamine and a tetracarboxylic acid dianhydride in the presence of a non-nucleophilic amine, providing an aqueous solution of the polyamic acid ammonium salt. Suitable methods for preparing polyamic acid aerogels under such aqueous conditions are disclosed in WO2022/125835 and PCT/US2023/016821, previously incorporated by reference.

In some embodiments, the aerogel of the present disclosure is a polyimide aerogel, in monolithic or bead form, wherein the polyimide is prepared by thermal or chemical imidization of a polyamic acid in aqueous solution. Suitable methods of forming monoliths and beads (e.g., utilizing droplet or emulsion-based processes) under such aqueous conditions are disclosed in WO2022/125835 and PCT/US2023/016821, previously incorporated by reference.

### Organic/Inorganic Hybrid Aerogels

Organic/inorganic hybrid aerogels are mainly comprised of (organically modified silica (“ormosil”) aerogels. These ormosil materials include organic components that are covalently bonded to a silica network. Ormosils are typically formed through the hydrolysis and condensation of organically modified silanes, R—Si(OX)₃, with traditional alkoxide precursors, Y(OX)₄. In these formulas, X may represent, for example, CH₃, C₂H₅, C₃H₇, C₄H₉; Y may represent, for example, Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

In certain embodiments, aerogels of the present disclosure are inorganic silica aerogels formed primarily from prepolymerized silica precursors preferably as oligomers, or hydrolyzed silicate esters formed from silicon alkoxides in an alcohol solvent. In certain embodiments, such prepolymerized silica precursors or hydrolyzed silicate esters may be formed in situ from other precurosrs or silicate esters such as alkoxy silanes or water glass. However, the disclosure as a whole may be practiced with any other aerogel compositions known to those in the art, and is not limited to any one precursor material or amalgam mixture of precursor materials.

### The Covalently Functionalized Silicon Particles

The composite material in accordance with the present disclosure includes a polymer network, e.g., a porous polymer network, with a plurality of functionalized silicon particles dispersed throughout the network. The functionalized silicon particles are silicon particles having covalently attached functional groups. In some embodiments, the covalently attached functional groups are selected from —OH, —COOH, —C—O—C—, —NH₂, —NHR, or combinations thereof. In some examples, covalently attached functional groups are formed from molecules selected from 3-aminopropyltriethoxysilane (APTES), 3-aminopropyltrimethoxysilane (APTMS), N-(2-aminoethyl)-3-aminopropyltriethoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof.

The silicon is generally present in the composite material as silicon particles. Within the context of the present disclosure, the term “silicon particles” refers to silicon or silicon-based materials with a range of particle sizes. The particle size of the silicon in the composite material may vary. Silicon particles of the present disclosure can be nanoparticles, e.g., particles with two or three dimensions in the range of about 1 nm to about 150 nm. Silicon particles of the present disclosure can be fine particles, e.g., micron-sized particles with a maximum dimension, e.g., a diameter for a substantially spherical particle, in the range of about 150 nm to about 10 micrometers or larger. The silicon particles may have two-dimensional plate shapes. The thicknesses of the two-dimensional plate shapes may range from about 20 nm to about 200 nm. The lengths of the two-dimensional plate shapes may range from about 20 nm to about 3 μm. For example, silicon particles of the present disclosure can have a maximum dimension, e.g., a diameter for a substantially spherical particle, of about 10 nm, 50 nm, 60 nm, 80 nm, 100 nm, 120 nm, 130 nm, 140 nm, 150 nm, 180 nm, 200 nm, 500 nm, 1 micrometer, 1.5 micrometers, 2 micrometers, 3 micrometers, 5 micrometers, 10 micrometers, 20 micrometers, 40 micrometers, 50 micrometers, 100 micrometers, or in a range between any two of these values.

In some embodiments, the silicon particles can be monodispersed or substantially monodispersed. In other embodiments, the silicon particles can have a particle size distribution. Within the context of the present disclosure, the dimensions of silicon particles are provided based upon the median of the particle size distribution, i.e., the D50. In some embodiments, the silicon in the composite material has an average particle size of about 1 m or less.

Silicon particles of the present disclosure can be silicon wires, crystalline silicon, amorphous silicon, silicon alloys, silicon oxides (SiOx), and any combinations thereof. The particles, e.g., particles of electroactive materials such as silicon particles, can have various shapes to embodiments disclosed herein. In some embodiments, silicon particles disclosed herein can be substantially spherical. In other embodiments, particles of electroactive materials can be substantially planar, cubic, obolid, elliptical, disk-shaped, or toroidal.

In an example, the silicon particle (e.g., silicon nanoparticle) surface can be modified with functional groups that can aid in dispersing the silicon particles in a porous three-dimensional network. In an example, the porous three-dimensional network can be a sol-gel, aerogel, xerogel, foam structure, among others. The functional groups that are grafted e.g., covalently attached onto the surface of the silicon particles can be chosen to aid in forming a uniform distribution of the silicon particles within the polymer network.

For example, functional groups can be grafted onto the surface of the silicon particles by covalent bonds. Before functionalization, the surface of the silicon particles includes silane groups, such as silicon hydride, and/or silicon oxide groups. In some embodiments, at least a portion of those silane and silicon oxide groups are provided in combination with the bonded functional groups after functionalization of the surface of the silicon particle, e.g., the silicon particle surface can include silane groups and the covalently attached functional groups, silicon oxide groups and the covalently attached functional groups, or both silane and silicon oxide groups and the covalently attached functional groups. The presence of the functional groups on the surface of the silicon particles can be detected by various techniques, for example, by infrared spectroscopy.

The surface of the silicon particles can be functionalized with hydrophilic groups to aid in improved dispersion within the polymer network. Without being bound by theory, the functionalization with hydroxide groups creates increased covalent bonding between the surface groups on the silicon particles and the polymer network. As a result, the functionalized silicon particles can be uniformly dispersed within the polymer network. For example, hydrophilic hydroxide groups can be grafted to the surface of the particles by unsaturated glycol to increase the hydrophilicity of silicon particle surfaces. Increasing the hydrophilicity of the silicon particles allows for the particles to be and remain more uniformly dispersed in the polymer network and remain uniformly dispersed in the network in any additional processing (e.g., pyrolysis). In an example, functionalization via glycol can improve the dispersion of silicon particles within a polyimide sol-gel and/or aerogel. Any suitable glycol can be used including, but not limited to, ethylene glycol methyl ether methacrylate, poly(ethylene glycol) methyl ether methacrylate, among others.

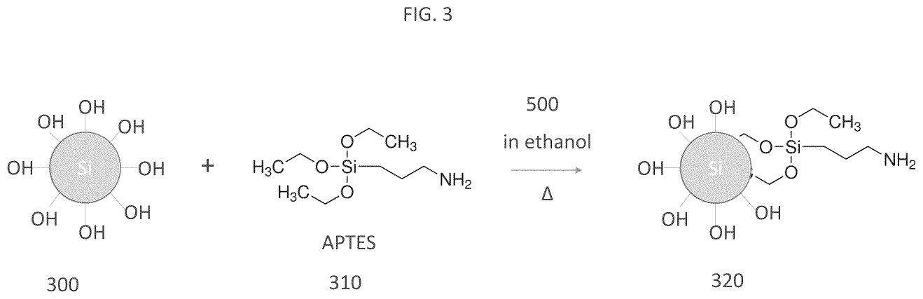

In another example, the functional groups can be reactive amino groups. For example, amino groups can be grafted to the surface of the silicon nanoparticles via covalent attachment of silane groups selected from 3-aminopropyltriethoxysilane (APTES), 3-aminopropyltrimethoxysilane (APTMS), N-(2-aminoethyl)-3-aminopropyltriethoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof. FIG. 3 illustrates the preparation scheme for silicon nanoparticles functionalized with APTES. Oxidized Si particles 300 are functionalized with 3-aminopropyltriethoxysilane 310 in an organic solvent e.g., ethanol with a heat treatment (500) to obtain APTES functionalized Si particles 320 in accordance with the present disclosure.

In some examples, the grafted amino groups can be used to covalently bond the Si particles to the polymer matrix. In some examples, the grafted amino groups can be used to bond the particles to the polymer matrix by hydrogen bonds.

In some examples, functional groups are selected from the group consisting of amino (—NRH), carboxylic acid (—C(O)OH) and derivatives, sulfonic acid (—S(O)₂—OH) and derivatives, carbonate (—O—C(O)—O—) and derivatives, hydroxyl (—OH), aldehyde (—CHO), ketone (—CRO), hydrazine (H₂N—NR—), isocyanate (—NCO), isothiocyanate (—NCS), phosphoric acid (—O—P(O)(OR)OH) and derivatives, phosphonic acid (—P(O)(OR)OH) and derivatives, haloacetyl, alkyl halides, maleimide, acryloyl, arylating agents like aryl fluorides, hydroxylamine, disulfides like pyridyl disulfide, vinyl sulfone, vinyl ketone, diazoalkanes, diazoacetyl compounds, epoxide, oxirane, aziridine, silicon-containing functional groups, carboxylic acid groups, sulfonic acid groups, boron-containing groups, phosphorus-containing functional groups, ammonium groups, and combinations of two or more of these, in which R is selected from the group consisting of H and linear, branched or cyclical alkyl groups which may contain further functional groups, hetero atoms or aryl groups.

The functional groups can be selected to participate in the reactions of polymer network formation. For example, the functionalization of the surface of the Si particles can be selected such that the functional groups can participate in reactions of polymer network synthesis.

In some embodiments, the functional groups aid in dispersing and maintaining the dispersion of the Si particles within the polymer network. In some embodiments, the individual covalently functionalized silicon particles within the plurality of covalently functionalized silicon particles are dispersed heterogeneously throughout the polymer network. In some embodiments, the individual covalently functionalized silicon particles within the plurality of covalently functionalized silicon particles are dispersed homogenously throughout the polymer network. The expression “homogenously dispersed” refers to a distribution of the Si particles throughout the polymer network without large variations in the local concentration across the accessible network surface.

In some embodiments, about 30 wt % to 70 wt % of the dispersed individual silicon particles within the plurality of silicon particles are in an agglomerated state. In certain embodiments, about 20 wt % to about 50 wt % of the dispersed individual silicon particles within the plurality of silicon particles are in an agglomerated state. In some embodiments, less than about 30 wt % (e.g., less than about 20 wt %, less than about 10 wt %, about 5 wt %) of the dispersed individual silicon particles within the plurality of silicon particles are in an agglomerated state. In some embodiments, homogenously distributed Si particles may refer to a distribution of the plurality of Si particles throughout the polymer network having less than about 30 wt %, less than about 20 wt %, less than about 10 wt % of the dispersed individual silicon particles within the plurality of silicon particles in an agglomerated state.

### The Composite Material

The composite material of the present disclosure comprises a polymer network, e.g., a porous polymer network, such as the polymer networks described above (e.g., inorganic aerogels, organic aerogels, organic/inorganic hybrid aerogels) with a plurality of the covalently functionalized silicon particles dispersed therein. In some embodiments, a composite material comprises: a plurality of silicon particles, wherein a surface of the plurality of the silicon particles includes covalently attached functional groups; and a polymer network, wherein individual silicon particles within the plurality of silicon particles are dispersed throughout the polymer network. In some embodiments, the covalently attached functional groups selected from —OH, —COOH, —C—O—C—, —NH₂, —NHR, or combinations thereof. In some examples, covalently attached functional groups are formed from molecules selected from 3-aminopropyltriethoxysilane (APTES), 3-aminopropyltrimethoxysilane (APTMS), N-(2-aminoethyl)-3-aminopropyltriethoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof.

The functionalized silicon particles may be introduced into the composite in various manners. The silicon particles may be introduced into the polymeric network, or may be introduced into a precursor of the polymeric network. For example, the silicon particles may be introduced into an aerogel before, during or after gelation of the gel material or precursor prior to drying. For example, in some embodiments, the aerogel is a polyamic acid, polyimide, or carbon aerogel prepared by pyrolysis of a polyamic acid or polyimide aerogel, and the polyamic acid or polyimide is prepared by an aqueous sol-gel process as described herein above. In such embodiments, the silicon particles may be introduced prior to gelation or after gelation of the polyamic acid or polyimide gel precursors. In particular embodiments, the silicon particles are introduced prior to gelation, during gelation, or both. Introduction of electroactive materials such as silicon particles prior to or during gelation of polyamic acid and polyimide gel materials is described in WO2022/125835, previously incorporated by reference.

The amount of silicon present in the composite material varies according to the density of the low bulk density carbon material, with lower densities resulting in higher weight percent incorporation of silicon. In some embodiments, the composite material comprises silicon in an amount by weight from about 20% to about 85%, such as from about 20%, about 25%, about 30%, about 35%, about 40%, about 45%, or about 50%, to about 55%, about 60%, about 65%, about 70%, about 75%, about 80%, or about 85% silicon by weight, based on the total weight of the composite material. In some embodiments, the composite material comprises silicon in an amount by weight from about 30% to about 35% by weight, based on the total weight of the composite material.

The composite material may be in a variety of different physical forms. In some embodiments, the composite material can take the form of a monolith. As used herein, the term “monolith” refers to materials in which a majority (by weight) of the low-density skeletal framework included in the composite material is in the form of a unitary, continuous, self-supporting object. With reference to aerogel materials, monolithic aerogel materials include aerogel materials which are initially formed to have a well-defined shape, but which can be subsequently cracked, fractured or segmented into non-self-repeating objects. For example, irregular chunks may be considered as monoliths. Monolithic aerogels may take the form of a freestanding structure, or a reinforced material with fibers or an interpenetrating foam.

In other embodiments, the composite material may be in particulate form, for example as beads or as particles from, e.g., crushing a monolithic material. As used herein, the term “beads” is meant to include discrete small units or pieces having a generally spherical shape. In some embodiments, the composite material beads are substantially spherical.

The composite material in particulate form can have various particle sizes. In the case of spherical particles (e.g., beads), the particle size is the diameter of the particle. In the case of irregular particles, the term particle size refers to the maximum dimension (e.g., a length, width, or height). The particle size may vary depending on the physical form, preparation method, and any subsequent physical steps performed. In some embodiments, the composite material in particulate form can have a particle size from about 1 micrometer to about 1 millimeter. For example, the composite material in particulate form can have a particle size of about 1 micrometer, about 2 micrometers, about 3 micrometers, about 4 micrometers, about 5 micrometers, about 6 micrometers, about 7 micrometers, about 8 micrometers, about 9 micrometers, about 10 micrometers, about 15 micrometers, about 20 micrometers, about 25 micrometers, about 30 micrometers, about 35 micrometers, about 40 micrometers, about 45 micrometers, about 50 micrometers, about 60 micrometers, about 70 micrometers, about 80 micrometers, about 90 micrometers, about 100 micrometers, about 200 micrometers, about 300 micrometers, about 400 micrometers, about 500 micrometers, about 600 micrometers, about 700 micrometers, about 800 micrometers, about 900 micrometers, about 1 millimeter, or in a range between any two of these values.

In some embodiments, the composite material has a particle size D90 value of less than or equal to 40 micrometers. In some embodiments, the composite material has a particle size D10 value of at least 1 micrometer. In some embodiments, the composite material has a particle size D50 in a range from about 5 micrometers to about 20 micrometers.

The density of the composite material may vary. In some embodiments, the composite material has a tap density in a range from about 0.15 g/cm³ to about 1.2 g/cm³.

The surface area of the composite material may vary. For example, the surface area may be up to about 100 m²/g, or may be greater than 100 m²/g. In some embodiments, the composite material has a surface area in a range from about 1 m²/g to about 400 m²/g, such as from about 1, about 10, or about 50, to about 100, about 200, about 300, or about 400 m²/g.

In some embodiments, the composite material comprises silicon in an amount by weight from about 20 to about 85%, such as from about 20, about 25, about 30, about 35, about 40, about 45, or about 50, to about 55, about 60, about 65, about 70, about 75, about 80, or about 85% silicon by weight, based on the total weight of the composite material.

The capacity of the composite material may vary. In some embodiments, the composite material has a specific capacity of at least about 400 mAh/g. In some embodiments, the composite material has a specific capacity of about 400, about 500, about 600, about 700, about 800, about 900, about 1000, or about 1100 mAh/g. In some embodiments, the composite material has a specific capacity of 1200 mAh/g or more, 1400 mAh/g or more, 1600 mAh/g or more, 1800 mAh/g or more, 2000 mAh/g or more, 2400 mAh/g or more, 2800 mAh/g or more, 3200 mAh/g or more, or in a range between any two of these values.

The electrical conductivity of the anode material may vary. Within the context of the present disclosure, the term “electrical conductivity” refers to a measurement of the ability of a material to conduct an electric current or other allow the flow of electrons there through or therein. Electrical conductivity is specifically measured as the electric conductance/susceptance/admittance of a material per unit size of the material. It is typically recorded as S/m (Siemens/meter) or S/cm (Siemens/centimeter). The electrical conductivity or resistivity of a material may be determined by methods known in the art, for example including, but not limited to: In-line Four Point Resistivity (using the Dual Configuration test method of ASTM F84-99). Within the context of the present disclosure, measurements of electrical conductivity are acquired according to ASTM F84-resistivity (R) measurements obtained by measuring voltage (V) divided by current (I), unless otherwise stated. In certain embodiments, anode materials of the present disclosure have an electrical conductivity of about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

### Lithium-Ion Batteries

A basic embodiment of a lithium-ion battery includes: a cathode; an anode in electrical communication with the cathode; an electrolyte disposed between the anode and the cathode; and a separator also disposed between the anode and the cathode.

The electrolytes are ionically conductive materials and may include solvents, ionic liquids, metal salts, ions such as metal ions or inorganic ions, polymers, ceramics, and other components. An electrolyte may be an organic or inorganic solid or a liquid, such as a solvent (e.g., a non-aqueous solvent) containing dissolved salts. Non-aqueous electrolytes can include organic solvents, such as, cyclic carbonates, linear carbonates, fluorinated carbonates, benzonitrile, acetonitrile, tetrahydrofuran, 2-methyltetrahydrofuran, γ-butyrolactone, dioxolane, 4 methyldioxolane, N,N-dimethylformamide, N,N-dimethylacetamide, N,N-dimethylsulfoxide, dioxane, 1,2-dimethoxyethane, sulfolane, dichloroethane, chlorobenzene, nitrobenzene, diethyleneglycol, dimethylether, and mixtures thereof. Example salts that may be included in electrolytes include lithium salts, such as LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y-1}SO₂), (where χ and y are natural numbers), LiCi, LiI, and mixtures thereof. In some embodiments, the liquid molecules comprise an electrolyte solvent (an electrolyte). The electrolyte solvent of the present disclosure can be selected from any of the suitable electrolyte described above. Particularly, the electrolyte is selected from ethylene carbonate (EC), diethyl carbonate (DEC), dimethyl carbonate (DMC), fluoroethylene carbonate (FEC), fluorinated ether (F-EPE), 1,3-dioxolane (DOL), dimethoxyethane (DME), or combination thereof.

The separators are typically thin, porous or semi-permeable, insulating films with high ion permeabilities. The separators can be composed of polymers, such as olefin-based polymers (e.g., polyethylene, polypropylene, and/or polyvinylidene fluoride). If a solid polymer electrolyte is used as the electrolyte, the solid polymer electrolyte may also act as the separator.

The anodes are composed of an active anode material that takes part in an electrochemical reaction during the operation of the battery. Example anode active materials include elemental materials, such as lithium; alloys including alloys of Si and Sn, or other lithium compounds; and intercalation host materials, such as graphite. By way of illustration only, the anode active material may include a metal and/or a metalloid alloyable with lithium, an alloy thereof, or an oxide thereof. Metals and metalloids that can be alloyed with lithium include Si, Sn, Al, Ge, Pb, Bi, and Sb. For example, an oxide of the metal/metalloid alloyable with lithium may be lithium titanate, vanadium oxide, lithium vanadium oxide, SnO₂, or SiOx (0<x<2).

The cathodes are composed of an active cathode material that takes part in an electrochemical reaction during the operation of the battery. The active cathode materials may be lithium composite oxides and include layered-type materials, such as LiCoO₂; olivine-type materials, such as LiFePO₄; spinel-type materials, such as LiMn₂O₄; and similar materials. The spinel-type materials include those with a structure similar to natural spinal LiMn₂O₄, that include a small amount nickel cation in addition to the lithium cation and that, optionally, also include an anion other than manganate. By way of illustration, such materials include those having the formula LiNi_{(0.5-x)}Mn_{1.5}MₓO₄, where 0≤x≤0.2 and M is Mg, Zn, Co, Cu, Fe, Ti, Zr, Ru, or Cr.

Within the context of the present disclosure, the term “cycle life” refers to the number of complete charge/discharge cycles that an anode or a battery (e.g., LIB) is able to support before its capacity falls under about 80% of its original rated capacity. Cycle life may be affected by a variety of factors, for example mechanical strength of the underlying substrate (e.g., carbon aerogel) and maintenance of interconnectivity of the aerogel. It is noted that these factors actually remaining relatively unchanged over time is a surprising aspect of certain examples of the present disclosure. Cycle life may be determined by methods known in the art, for example including, but not limited to, cycle testing, where battery cells are subject to repeated charge/discharge cycles at predetermined current rates and operating voltage. Within the context of the present disclosure, measurements of cycle life are acquired according to this method, unless otherwise stated. Energy storage devices, such as batteries, or electrode thereof, can have a cycle life of about 25 cycles or more, 50 cycles or more, 75 cycles or more, 100 cycles or more, 200 cycles or more, 300 cycles or more, 500 cycles or more, 1000 cycles or more, or in a range between any two of these values.

The present disclosure includes an electrical energy storage device with at least one anode comprising the composite material of present technology as described herein, at least one cathode, and an electrolyte with lithium ions. The electrical energy storage device can have a first cycle efficiency (i.e., a cell's coulombic efficiency from the first charge and discharge) of at least 10%, 20%, 30%, 40%, 50%, 60%, 70%, any intervening value (e.g., 65%) or in a range between any two of these values (e.g., ranges from about 30% to about 50%). As previously described herein, reversible capacity can be at least 150 mAh/g. The at least one cathode can be selected from the group consisting of conversion cathodes such as lithium sulfide and lithium air, and intercalation cathodes such as phosphates and transition metal oxides.

According to different embodiments, the composite materials of the present disclosure may be applied to both the positive electrode and the negative electrode of electrochemical energy storage devices, or to the electrodes individually (either the positive electrode or the negative electrode). In various embodiments, a cathode, anode, or solid state electrolyte material is coated with the composite materials of the present technology.

### EXAMPLES

The following examples are included to demonstrate preferred embodiments of the technology. However, those of skill in the art should, in light of the present disclosure, appreciate that many changes can be made in the specific embodiments which are disclosed and still obtain a like or similar result without departing from the spirit and scope of the technology.

### 1.1 Pretreatment of Silicon Particles

The dispersion of the silicon particles within the polymer network is enhanced by their pretreatment and or functionalization to create desired surfaces. Three different types of silicon particles (synthesized from gas deposition; milled silicon; and metallurgic silicon) were used in these examples. The particles from the different types of silicon can be pretreated and/or functionalized.

### 1.1.1 Oxidation of Synthesized Silicon Particles

Commercially available silicon particles (synthesized from gas deposition) may or may not include oxidized (partially or completely) silicon particles. Therefore, depending on the surface functionalities of silicon particles provided by commercial providers, the oxidation step provided herein is optional.

For silicon particles that are hydrogen terminated, an increase in hydrophilicity is desired. Oxidation of these hydrogen terminated particles is one way to increase hydrophilicity. Oxidation of 10-100 g of 100-3000 nm silicon particles (Available from Evonik) was accomplished by either (1) heating the particles in the temperature range of 400-850° C. under moisture for 1-5 h, or (2) dispersing the particles in 0.01-1 M of 10-1000 mL sulphochromic acid mixed with 1-10 M of 10-1000 mL H₂O₂ (hydrogen peroxide). For the Si dispersion, it was heated to 50-120° C. for 1-10 hour under constant stirring in order to obtain hydroxyl functional groups (or silanol groups) or in some instances, Si—O terminated groups on the surface of silicon particles. In principle, other oxidizing agents can also be used for this purpose. After 1-10 hour of stirring the solution, the solution was cooled to room temperature and centrifuged to obtain oxidized silicon particles. The obtained silicon particles were washed with 100-3000 mL volume of water for 3-5 times to remove any residual acid and dried under ambient conditions for 3-10 hours. The surface oxidation was confirmed by IR spectrum as evidenced by the reduced intensity of band at 2105 and 1993 cm⁻¹ and the increase of band intensity at 1052 cm⁻¹. The oxidation by heating dry powder can also be confirmed by the mass increase after the treatment.

### 1.1.2 Pretreatment of Milled Silicon

Mechanical milling is employed to create milled Silicon particles. Typically, solvents, such as, IPA are used during mechanical milling. As a result, the surface of milled Silicon particles contains an alkyl group—making the particles hydrophobic. To enhance the dispersive capabilities of the milled particles two different approaches were used. In one approach, hydrogen peroxide (H₂O₂) is used as a pretreatment step to remove the alkyl group from the surface of the milled particle. There afterwards, the functionality of the particle can be increased by an optional addition of AEAPTMS (see section 1.2 below).

An alternative approach to using a pretreatment step to eliminate the alkyl group, is to incorporate AEAPTMS as a solvent at the conclusion of milling. That is, if a portion of the surface active sites are not grafted with alkyl group (i.e., from interaction with the IPA), then that portion will then be grafted with AEAPTMS. Likely, the surface of these particles after interaction with IPA and AEAPTMS solvents will still have alkyl groups on the surface, but the AEAPTMS will increase the hydrophilicity and will dominate the dispersibility of the milled Silicon particles.

A further approach is to add a surfactant, such as a cationic, anionic, or nonionic surfactant to the IPA solvent after milling. The surfactant can be Tween 20, Tween 80, sodium lauryl sulfate (SDS) and cetyl trimethylammonium bromide (CTAB), or a sorbitan monolaurate, sorbitan monostearate, or sorbitan tristearate. A surfactant can be incorporated in either of the two alternative approaches described above. That is, in one embodiment, Tween 20 was added to the IPA after milling, and then H₂O₂ was used as a pretreatment step to remove the alkyl group from the surface of the milled particle followed by an optional AEAPTMS functionalization. In another embodiment, Tween 80 was combined with IPA after milling, followed by AEAPTMS functionalization.

### 1.1.3 Pretreatment of Metallurgical Silicon Particles

In the event that metallurgical silicon particles are used, such as SILGRAIN® e-SI 408 (metallurgical grade silicon having a particle size of 0-8 μm) or SILGRAIN® HQ MicronCut (metallurgical grade silicon having a particle size of 0-10 μm) both commercially available from Elkem, various pretreatment options prior to an optional functionalization with AEAPTMS are available. Metallurgical silicon, or metallurgical grade silicon, is the result of purifying silicon using heat and one or more reducing agents. Typically, metallurgical silicon has a purity of 99% or greater.

In this example, three different pretreatment options were used. A first pretreatment option consisted of no pretreatment. That is, the metallurgical grade silicon was not subjected to any pretreatment steps (was used “as is” from commercial vendor) prior to optional functionalization with AEAPTMS (See section 1.2 below).

A second type of pretreatment step applied when using metallurgical silicon consisted of pyrolysis of the metallurgical grade silicon in an inert atmosphere up to 850 C.

A third type of pretreatment step applied when using metallurgical silicon consisted of oxidation under moisture (e.g., water vapor) at a temperature within the range of 400 to 850 C.

### 1.2 Synthesis of AEAPTMS Functionalized Si Particles

To further increase the hydrophilicity of the pretreated silicon particles, an optional functionalization with AEAPTMS is used. This optional AEAPTMS functionalization can be applied to oxidized synthesized silicon particles (i.e., see section 1.1.1 above), as an optional step after pretreatment of milled silicon particles (i.e., see section 1.1.2 above), or after pretreatment of metallurgical silicon particles (i.e., see section 1.1.3 above).

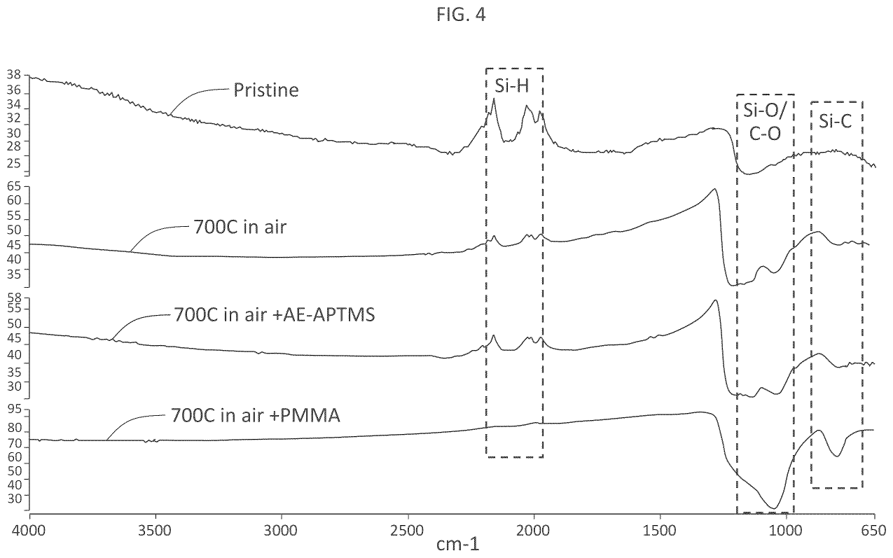

The following procedure was used to functionalize oxidized synthesized Silicon particles. 20 gram of oxidized silicon particles was dispersed in 80 mL of ethanol. The dispersion was sonicated for 30 minutes to prevent agglomeration of the silicon particles. Then, 2 grams of AEAPTMS was added to the dispersion and stirred for 240 minutes on a hot plate with dispersion temperature controlled at 70° C. The dispersion was left still overnight to let silicon particles precipitate, after which the top clear solvent was poured out and left silicon slurry was centrifuged to remove residual solvent. The collected silicon particles were kept wet until being dispersed in PI sol. The surface functionalization of the modified silicon particles was confirmed by IR spectrum (FIG. 4) with characteristic peak of Si—C bond at about 780 cm⁻¹.

1.3 Synthesis of Composite Si/PI and Si/C Materials that Contain AEAPTMS Functionalized Si Particles

In a typical synthesis, 12.7 g of p-phenylenediamine (PDA) was added to 313 g water in a beaker and stirred for 30 min until all the PDA was dissolved. Then 28.5 g of triethylamine was added to the solution and stirred for 10 min. After that, 25.5 g of benzene-1,2,4,5-tetracarboxylic anhydride was added to the above solution and stirred for 4 h. Then, 1.5 to 55 g AEAPTMS modified Si particles were added to the above solution and stirred for 10 min. 51.4 g acetic anhydride was then poured into the above suspension and stirred for 50 s before pouring it all into 1200 mL mineral spirits with surfactant under mixing at 3600 rpm. The obtained emulsion was then aged overnight before running the filtration. After finishing filtration, the obtained material was rinsed with ethanol several times and dried in the oven at 70° C. The final product was obtained by carbonizing the above dried material at 800-1200° C. under inert gas atmosphere (for example, N₂ or Ar) for 2-10 h.

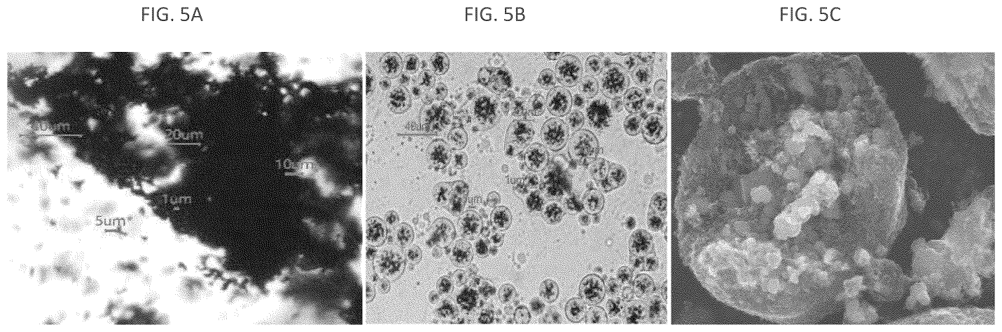

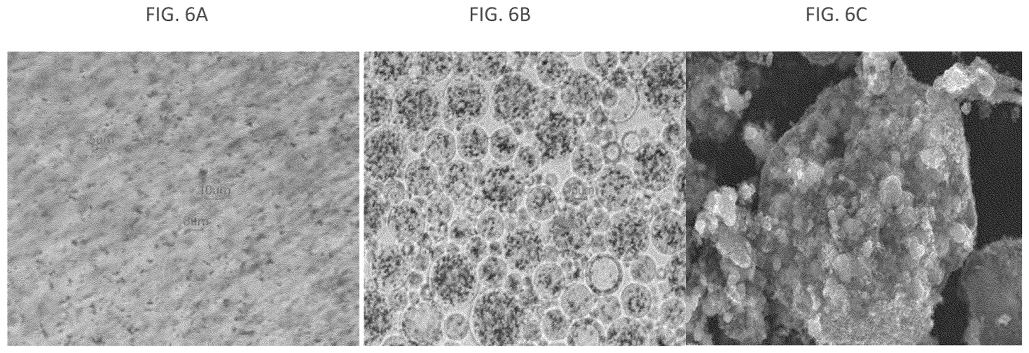

Scanning electron microscope (SEM) images of AEAPTMS functionalized Si particles in the sol (FIG. 6A), polyimide beads including AEAPTMS functionalized Si particles in the sol (FIG. 6B) and carbonized polyimide beads (carbon beads) including AEAPTMS functionalized Si particles (on a carbon tape) (FIG. 6C) are compared with pristine Si particles in the sol (FIG. 5A), polyimide beads including pristine Si particles in the sol (FIG. 5B) and carbonized polyimide beads (Si/C beads) including AEAPTMS functionalized Si particles (on a carbon tape) (FIG. 5C). SEM images taken in the sol systems show the effect of AEAPTMS functionalization on the dispersion properties of Si particles. AEAPTMS functionalized Si particles are dispersed better in PI beads without significant aggregations of particles compared to pristine particles. Similarly, functionalized Si particles in Si/C beads shown in FIG. 6C show lack of aggregation of Si particles which is observed in FIG. 5C.

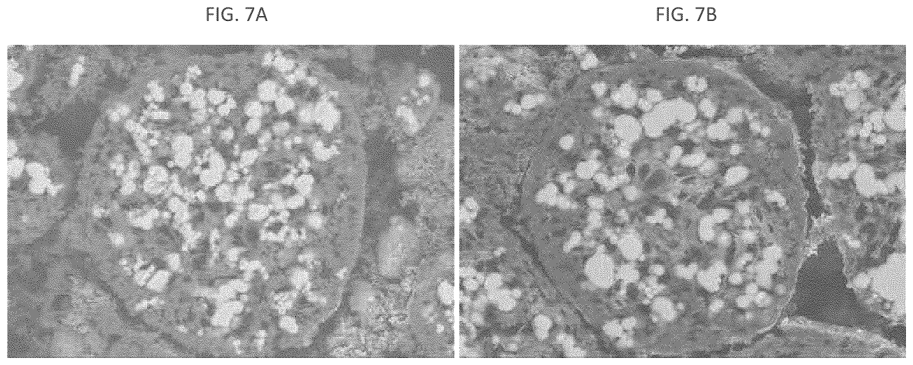

Another example of a composite material including carbonized polymer network (carbon beads) with well dispersed silicon particles is shown in FIG. 7A and FIG. 7B. The silicon particles were surface modified to promote dispersion in the sol. The composite materials shown in FIG. 7A and FIG. 7B have 53 wt % Si; a BET surface area of 22.24 m²/g; a particle size D10: 6.5 μm, D50: 10.4 μm: D90, 15.5 μm; and a tap density of 0.6 g/cc.

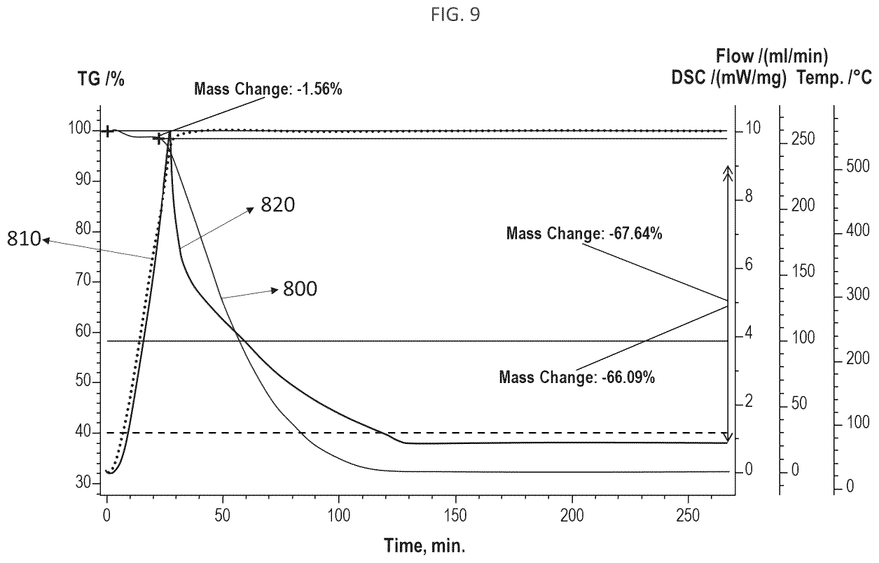

Carbonized Si/C particles shown in FIG. 6C are further characterized to measure particle size distribution using HORIBA Laser Scattering Particle Size Distribution Analyzer LA-960. Particle size distribution histogram of Si/C particles shown in FIG. 9 (mean size: 18.1 μm; D50: 11.1 μm; D10: 6.6 μm; D90: 19.2 μm).

TGA (thermal gravimetric analysis) is used to measure the mass percentage of Si in the Si/C beads (FIG. 9). 0.05-0.3 g of Si/C beads are heated up to 550° C. at a rate of 20° C./min in air and are held at 550° C. for 4 hours. At these measurement conditions, while carbon of Si/C beads is burned off, Si is not oxidized significantly. The results show that Si content of Si/C beads are above % 65 of Si/C beads by weight. The initial mass loss observed in FIG. 9 is due to solvent evaporation (e.g., water), and the mass change obtained during the temperature ramp of TGA reflects the burning of the carbon content in the Si/C composite. After the 4 hours hold at 550° C., a total of 67.64% of Si/C beads is burned away. Considering solvent mass loss, when solvent mass loss is subtracted from the mass change at the end of the temperature program, the resulting mass (66.09%) is equal to the mass of the carbon. Oxidation of Si is considered while calculating the carbon content and necessary calibration is made to accommodate any error that may come from the possible oxidation of Si.

Surface area and pore volume of Si/C particles are measured via BET analysis (shown in Table 1). Surface area was measured via BET (Brunauer, Emmett and Teller) analysis, conducted using a Micromeritics TriStar II 3020 instrument. Sample material was placed in a 12 mm sample tube with a uniform initial weight of approximately 0.0475 grams. The samples were degassed for at least 24 hours at 80° C. prior to analysis. Nitrogen was used as the analyte gas. The BJH (Barrett, Joyner and Halenda) method was applied to desorption data to determine pore volume and diameter.

TABLE 1
BET surface area, total pore volume and pore diameter of
carbonized Si/C aerogels and xerogel particles.

| | | | Pore volume | |
|---|---|---|---|---|
| | | Pore | (BJH Desorption | Average |
| | | volume | cumulative volume | pore |
| | BET | (single | of pores between | diameter |
| | surface | point | 17.000 Å and | (BJH |
| | area | desorption), | 3,000.000 Å | desorption), |
| Samples | (m²/g) | cm3/g | width), cm3/g | Å |
| Xerogel Si/C | 4.28 | 0 | 0 | N/A |
| (pristine Si) | | | | |
| Aerogel Si/C | 67.68 | 0.195 | 0.182 | 231.86 |
| (pristine Si) | | | | |
| Xerogel Si/C | 16.22 | 0.03 | 0.028 | 364.4 |
| (modified Si) | | | | |
| Aerogel Si/C | 56.26 | 0.096 | 0.079 | 176.99 |
| (modified Si) | | | | |

Table 1 shows the surface area and pore volume of aerogel and xerogel Si/C particles. The surface area of xerogel Si/C particles and aerogel Si/C particles that are suitable for the present technology may be in the range of 0-60 m²/g and 30-180 m²/g, respectively. The pore volume for the xerogel Si/C particles and aerogel Si/C particles would be in the range of 0-0.2 cm³/g and 0.1-1.0 cm³/g.

While this disclosure has been particularly shown and described with reference to example embodiments thereof, it will be understood by those skilled in the art that various changes in form and details may be made therein without departing from the scope of the technology encompassed by the appended claims.

What is claimed is:

1. A composite material comprising:
a. a plurality of silicon particles, wherein a surface of the plurality of the silicon particles includes covalently attached functional groups selected from —OH, —COOH, —C—O—C—, —NH₂, —NHR, or combinations thereof; and
b. a polymer network, wherein individual silicon particles within the plurality of silicon particles are dispersed throughout the polymer network.

2. The composite material of claim 1, wherein the surface of the individual silicon particles within the plurality of silicon particles includes silane groups.

3. The composite material of claim 1, wherein covalently attached functional groups are formed from molecules selected from 3-aminopropyltriethoxysilane (APTES), 3-aminopropyltrimethoxysilane (APTMS), N-(2-aminoethyl)-3-aminopropyltriethoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof.

4. The composite material of claim 1, wherein the polymer network comprises an aerogel, a xerogel, an ambigel, an aerogel-xerogel hybrid material, an aerogel-ambigel hybrid material, an aerogel-ambigel-xerogel hybrid material, or combinations thereof.

5. The composite material of claim 1, wherein the polymer network comprises a polyimide or is derived from a polyimide.

6. The composite material of claim 1, wherein the polymer network is in the form of a bead.

7. The composite material of claim 6, wherein the bead is substantially spherical, having a diameter from about 100 nm to about 4 mm, or from about 5 μm to about 4 mm.

8. The composite material of claim 1, wherein the polymer network has bulk density in the range of about 0.25 g/cc to about 1.0 g/cc.

9. The composite material of claim 1, wherein the polymer network comprises a skeletal framework comprising nanofibers, the skeletal framework comprising an array of interconnected pores.

10. The composite material of claim 1, wherein the polymer network is a porous polymer network having a pore volume of at least 0.3 cc/g.

11. The composite material of claim 10, wherein a pore structure of the polymer network includes a pore size at max peak from distribution of about 150 nm or less.

12. The composite material of claim 1, wherein the individual silicon particles within the plurality of silicon particles have a particle diameter in the range of about 150 nm to about 1000 nm.

13. The composite material of claim 1, wherein the polymer network comprises from about 20% to about 95% by weight of the plurality of silicon particles, based on the total weight of the composite material.

14. The composite material of claim 1, wherein a volume of the plurality of silicon particles comprises between 35% to 60% of a volume of the polymer network.

15. The composite material of claim 1, wherein individual silicon particles within the plurality of silicon particles are present at least partially within the pore structure of the polymer network, or wherein the individual silicon particles within the plurality of silicon particles are dispersed heterogeneously throughout the polymer network.

16. The composite material of claim 1, wherein about 20 wt % to about 50 wt % of the dispersed individual silicon particles within the plurality of silicon particles are in an agglomerated state.

17. The composite material of claim 1, wherein less than about 20 wt % of the dispersed individual silicon particles within the plurality of silicon particles are in an agglomerated state.

18. The composite material a of claim 1, wherein the polymer network comprises a carbonized aerogel, a carbonized xerogel, a carbonized ambigel, a carbonized aerogel-xerogel hybrid material, a carbonized aerogel-ambigel hybrid material, a carbonized aerogel-ambigel-xerogel hybrid material, or combinations thereof.

19. A rechargeable battery comprising the composite material of claim 1.

20. A method of preparing a composite material, the composite material comprising a polymer network and a plurality of silicon particles, individual silicon particles within the plurality of silicon particles are dispersed throughout the polymer network, the method comprising:
a. providing a plurality of silicon particles;
b. optionally oxidizing a surface of the plurality of the silicon particles to obtain hydroxyl functional groups (or silanol groups) on the surface;
c. covalently reacting hydroxyl functional groups on the surface with molecules including functional groups to obtain covalently attached functional groups on the surface of individual silicon particles within the plurality of silicon particles;
d. providing a sol-gel solution, the sol-gel solution comprising a polar solvent and a precursor of the polymer network;
e. processing the plurality of silicon particles in the presence of the sol-gel solution to yield a polymer network comprising the plurality of silicon particles, wherein individual silicon particles within the plurality of silicon particles are dispersed throughout the polymer network.
